(19) United States
(12) Patent Application Publication
(10) Pub. No.: US 2009/0232654 A1
(43) Pub. Date: Sep. 17, 2009

(54) Andrews turbine

(76) Inventor: Jack Kelso Andrews, Houston, TX (US)

Correspondence Address: JACK K. ANDREWS, 15027 TILLEY, HOUSTON, TX, 77084, US

(21) Appl. No.: 12/321,659

(22) Filed: Jan. 22, 2009

Related U.S. Application Data
(60) Provisional application No. 61/062,935, filed on Jan. 30, 2008.

(51) Int. Cl. F03D 3/06; F03D 11/02; F03D 9/00; F03B 13/00

(52) U.S. Cl. 416/124; 290/55

(57) ABSTRACT

The Andrews Turbine is a vertical axis turbine (FIGS. 4/8 and 5/8). The blades are unique in that they are wider on the trailing edge than the leading edge and they contain vertical partitions within the blade (FIG. 1/8). This design offers more resistance on the trailing edge and keeps the blade turning in the same direction. The vertical partitions create turbulence within the blade, imparting increased torque to the drive axle. Another unique feature is the vertical axle with horizontal blades (FIGS. 4/8 and 5/8). With numerous equally offset blades, a symmetric distribution of the blades is created, referred to as a rotor set (FIG. 3/8). By adding rotor sets (FIG. 6/8) the power of the Andrews Turbine is increased. The Andrews Turbine can be used as a wind or water turbine and as a vehicle turbine without changing the design.

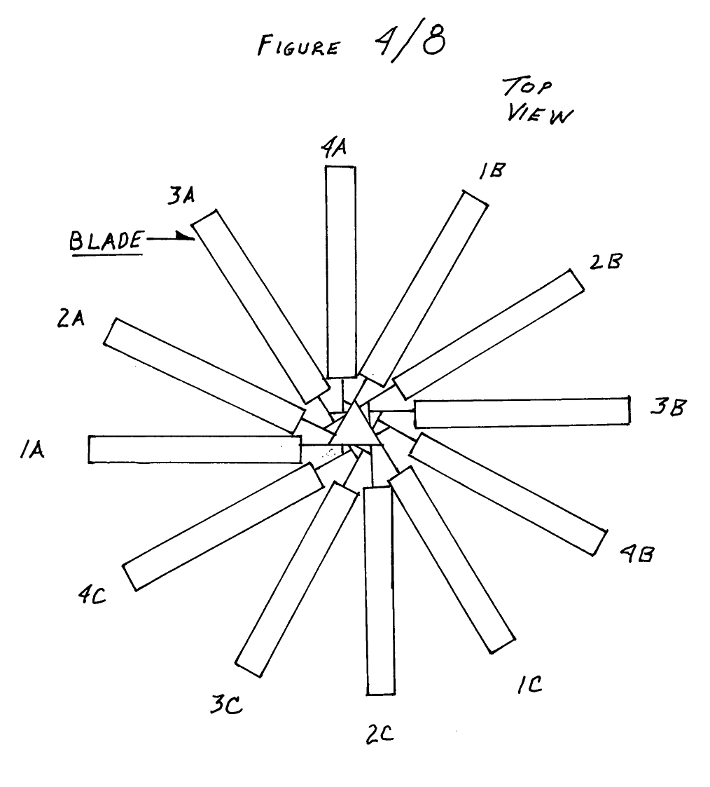

The Andrews Turbine is a relatively simple vertical axis turbine design that can be utilized to extract energy from nature for the purpose of generating electricity. The Andrews Turbine contains many new and revolutionary design features that eliminate many of the short comings of present vertical axis wind turbines. The design of the blades is new and offers many advantages over past designs. The overall configuration of the Andrews Turbine with a vertical axis and horizontal blade is revolutionary and allows the turbine to occupy a small volume while delivering enough power to drive a high ratio gearbox. The power can be increased by adding rotor sets to the turbine, while still maintaining a relatively small package. The combination of the new design features allows the Andrews Turbine to generate electricity from either wind or water without changing the design or components. FIGS. 4/8 and 5/8 illustrate the components of the Andrews Turbine.

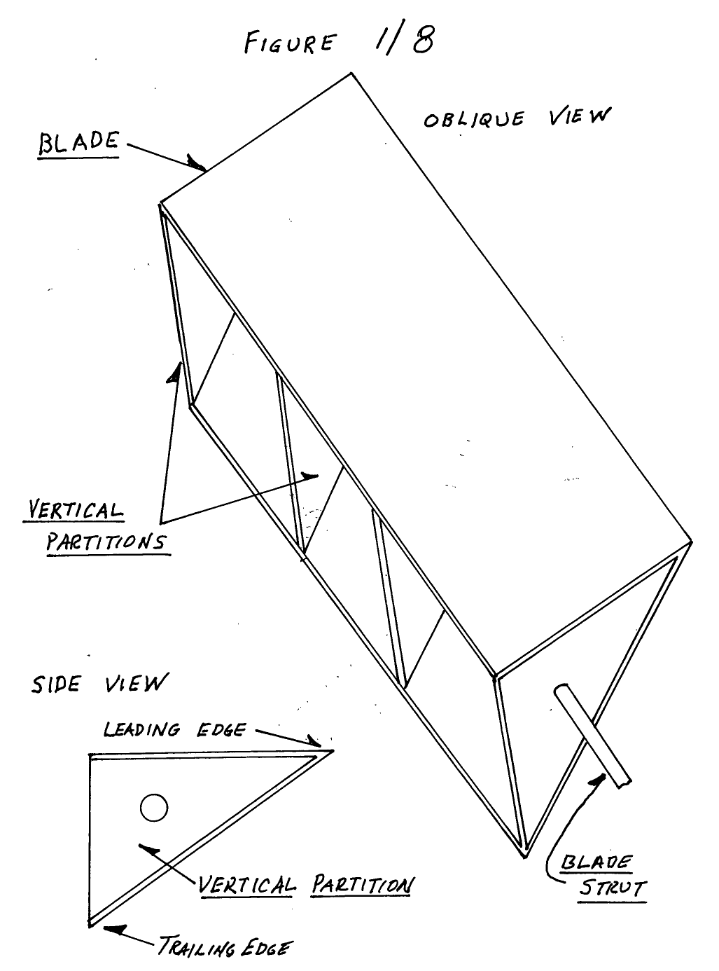

Blades: FIG. 1/8

The blades are thinner on the leading edge than the trailing edge and the interior of the blade is hollow or concave. The blades are designed to offer more resistance on the trailing edge than the leading edge, this keeps the blade rotating in the same direction. The length, width and height of the blade can vary, depending on application and materials.

The Andrews Turbine can rotate either clockwise or counterclockwise, depending on the orientation of the blades. The power of the Andrews Turbine is increased by adding additional blades, this does not increase the speed of the drive axle but rather the amount of torque transferred to the drive axle.

Vertical Partitions: FIG. 1/8

Each blade in an Andrews Turbine has vertical partitions within the concave portion of the blade. The number and spacing of the vertical partitions can vary, depending on size and application. The purpose of the vertical partitions is to create directed turbulence within the interior of the blade which extracts more energy from the environment. The energy generated by the turbulence is transferred to the drive axle in the form of torque.

Blade Strut: FIG. 1/8

The blades struts attach the blades to the hubs. If the hubs are not used, the blade struts would attach the blades directly to the drive axle.

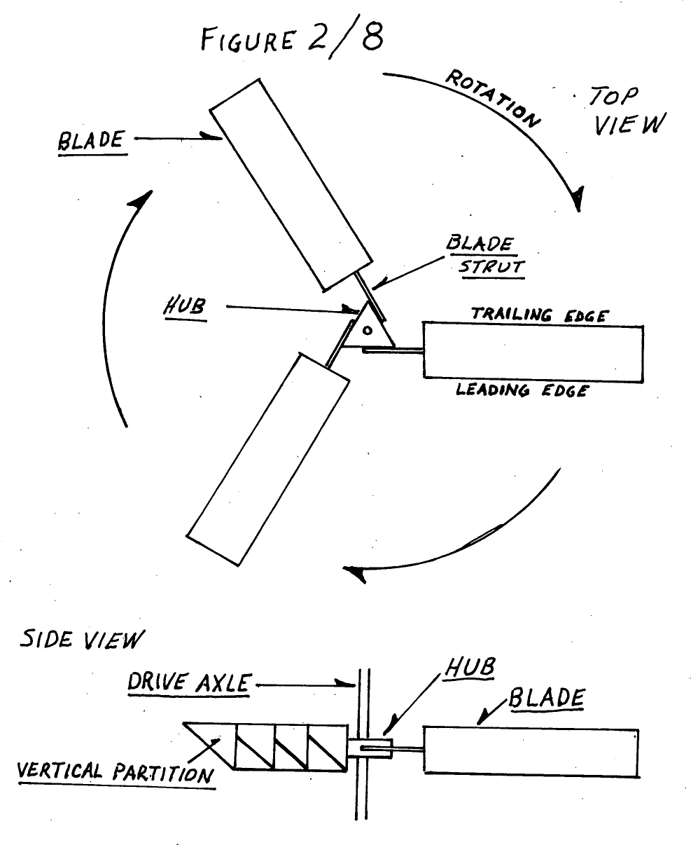

Hub: FIG. 2/8

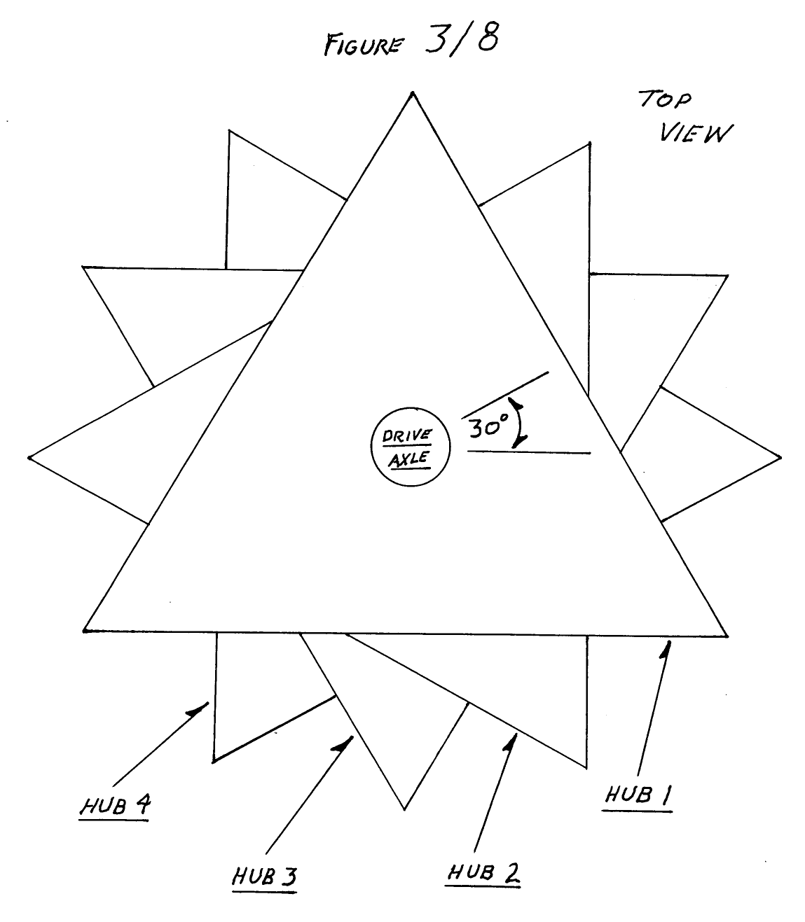

The hub is a device to attach the blades to the drive axle in a symmetrical pattern. The hubs are symmetrical with a hole in the middle for attaching the hub to the drive axle, the blades are attached to the sides of the hub. When attaching the hub to the drive axle the hubs are offset from adjacent hubs (FIG. 3/8), resulting in evenly spaced blades around the drive axle (FIG. 4/8). This eliminates the requirement to orient the turbine into the changing wind direction.

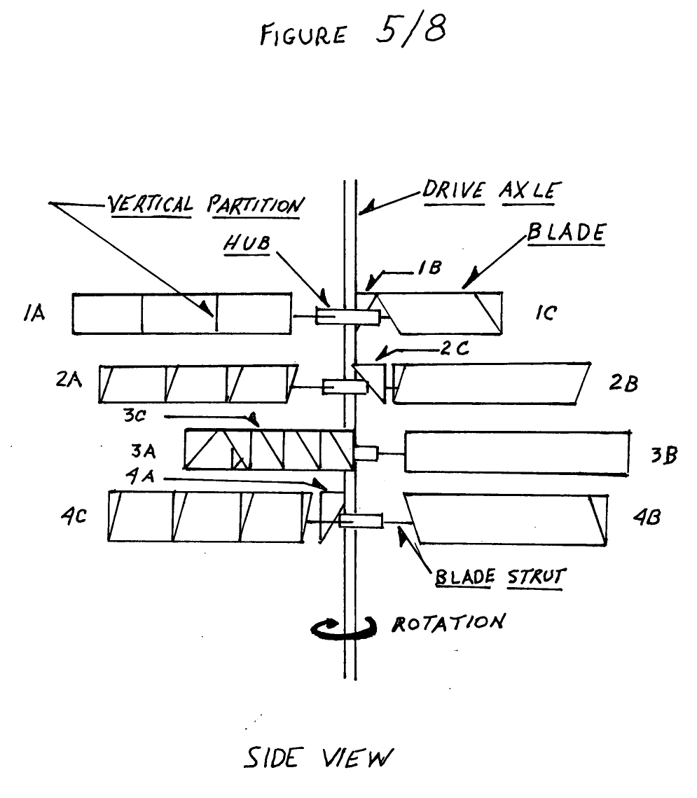

Drive Axle: FIG. 5/8

The drive axle transfers the energy generated by the blades to the gearbox/generator. The drive axle is oriented in a vertical position while the blades are horizontal. The drive axle can rotate in a clockwise or counter clockwise direction and is directly attached to the gearbox.

Rotor Set: FIGS. 4/8 and 5/8

A rotor set is a group of blades and hubs offset from one another such that there is a symmetrical distribution of the blades around the drive axle and no two blades are in the same vertical plane. FIG. 3/8 illustrates that with a three sided hub that is offset from adjacent hubs by 30° four hubs are required to provide a complete and symmetrical pattern of blades through a 360° circle. In this example there are four hubs and twelve blades to a rotor set. A hub with a different design would have a different number of hubs and blades in each rotor set. When increasing the power of an Andrews Turbine it is best to add additional blades as a rotor sets in order to provide a balanced distribution of power.

Andrews Wind Turbine

The Andrews wind turbine is a vertical axis wind turbine (VAWT). There are two general types of wind turbines, horizontal axis wind turbine (HAWT) and vertical axis wind turbine (VAWT). So far the HAWT's have been the more successful and best known wind turbine. The HAWT consists of two or more blades, a gearbox, generator, and auxiliary motors, sensors and mechanisms. To increase efficiency, they are mounted on tall towers to take advantage of faster and less turbulent winds with altitude. The blades are designed to provide lift, enabling the blades to turn faster than the wind velocity. Currently all utility and most small applications are HAWT design.

There are inherent disadvantages to the HAWT design that increases complexity, therefore the cost and reliability, of the HAWT turbine. The blades must be precisely manufactured to provide maximum lift. In high winds the blades must be retarded by changing the pitch of the blade and by braking the drive axle. The blades must also be reoriented into the wind as the wind changes direction. The gearbox must be robust because it bears the weight of the blades and drive axle. The mechanical complexity of HAWTs increases the cost to manufacture and maintain the equipment. Other problems with HAWTs are the noise they create and the large number of birds killed by the blades. The public outcry has affected the acceptance and locations of some HAWT projects.

Generally most VAWTs are of two basic designs. The Darrius turbine has two long vertical blades mounted on a vertical shaft. The Giromill turbine is a variation of the Darrius turbine. The Giromill turbine has two or more vertical blades which can be straight, y-shaped or curved. The Savonious turbine has two or more vertical, scooped shaped blades driving a vertical axis. These blades are usually mounted near the ground.

The advantages of VAWTs derive from its vertical axis. The foundation or generator bears the weight of the blades and drive axle allowing for a less robust gearbox. Because the blades are symmetrical about the axle, there is no requirement to orient the blades into the wind. The simplicity of design greatly reduces the cost of manufacturing and maintaining VAWTs. One shortcoming of the VAWT is the difficulty of mounting them on a tall tower. The blades are generally a drag type design allowing the blades to turn no faster than the wind speed. VAWTs are difficult to start in low wind speeds because of the limited torque which also makes high ratio gearboxes impractical. Increasing the size of the VAWTs without developing a pulsating torque has proven difficult.

The Andrews Turbine is a revolutionary new design because while the drive axle is vertical, the blades are horizontal (FIGS. 4/8 and 5/8). By mounting the blades horizontally it is possible to mount numerous blades in a relatively small volume. The Andrews Turbine retains all the beneficial characteristics of VAWTs such as simplicity of manufacturing and maintenance, while overcoming the shortcomings such as mounting on tall towers, starting in low winds and driving a high ratio gearbox.

Regardless of application, the Andrews Turbine consists of two or more blades (FIGS. 1/8 and 2/8) symmetrically attached to the hub. Two or more blades attached to the drive axle (FIGS. 3/8 and 4/8). The blades are elongated with the leading edge narrower than the trailing edge and are concave along its length with partitions at each end and with one or more partitions within the hollow part of the blade (FIG. 1/8). These partitions create turbulence within the concave portion of the blade which results in increased energy transfer to the blade. Because blades are symmetric about the hub and are in the same horizontal plane (FIG. 2/8), the hub us designed so the blades do not interfere with the air flow to the other blades. When attaching the hubs to the drive axle, the hubs are offset from the hubs above and below allowing full 360° coverage (FIG. 3/8).

In order to increase the output of any turbine it is necessary to increase to horsepower of the turbine. One horse power is equivalent to 746 watts and is expressed as torque X rpm/63,000. To date manufacturers increase the horsepower of wind turbines by increasing the size and speed of the blades and by using high ratio gearboxes. Observations during tests of the Andrews Turbine show that as hub assemblies are added, the rpm remains the same but the force needed to brake the drive axle increases, indicating an increase in torque. The horsepower of the Andrews Turbine is increase by increasing the torque of drive axle not by increasing the rpms. The ability to turn slowly with high torque makes the Andrews Turbine superior mechanically to other designs and lends itself to multiple applications.

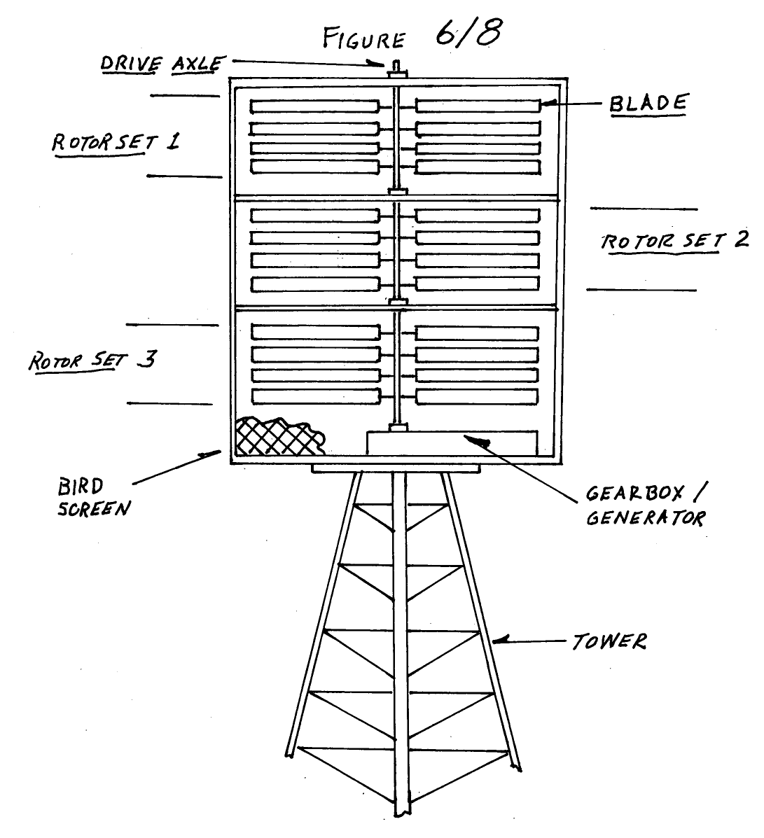

The Andrews Turbine for small applications can have blades approximately three feet long and two inches high at the trailing edge. If each blade is mounted six inches from the centerline of the drive axle the blades define a seven foot diameter of rotation. Using a hub that is an equilateral triangle three blades can be attached to the hub without the blades interfering with the air flow to other blades on the same horizontal plane. With this arrangement, the hub and three blades are referred to as a hub assembly (FIG. 2/8). When attaching the hub assemblies to the drive axle each hub assembly is rotated 30° from the adjacent hub assembly resulting in a complete 360° coverage with four hub assemblies (FIG. 3/8). These four hub assemblies (12 blades) are referred to as a rotor set (FIGS. 4/8 and 5/8). With this example each rotor set occupies a cylindrical volume of seven feet in diameter and sixteen inches high and contains the equivalent of three blades with a turning diameter of twenty-eight feet. By mounting three rotor sets in a cylindrical volume of seven feet in diameter and five feet in height, you have the equivalent of three blades with a turning diameter of eighty-four feet. The small volume occupied by the turbine allows for mounting on a tall tower and the installation of a screen to keep birds away from the blades (FIG. 6/8). The slow turning blades do not create noise and the high torque allows for a high ratio gearbox which can turn the generator fast enough to generate electricity.

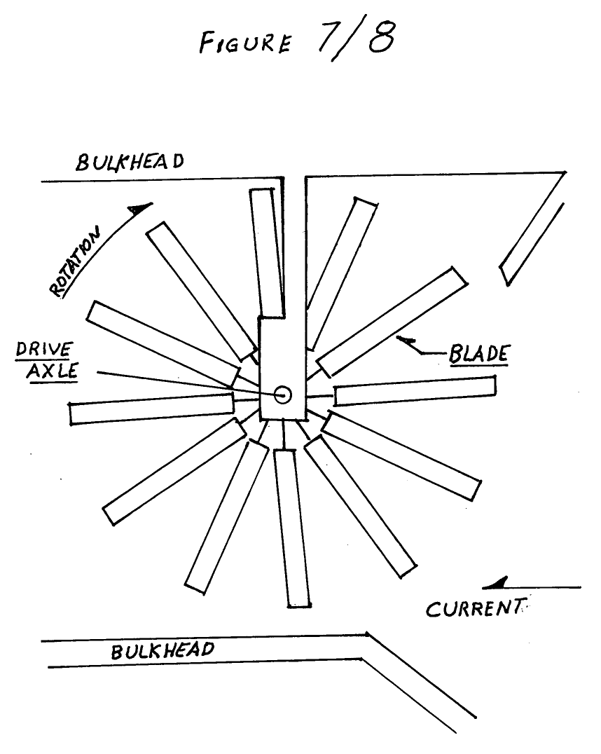

Because the Andrews Turbine can generate high torque while turning slowly, the Andrews Turbine can also be powered by water flow even if the current is slow. The blades with the vertical partitions can generate enough torque to keep the drive axle turning in a constant direction. While the drive axle is turning slowly, the high ratio gearbox can turn the generator fast enough to generate electricity. The design of the Andrews Turbine for hydroelectric applications is the same as for wind generation (FIG. 7/8).

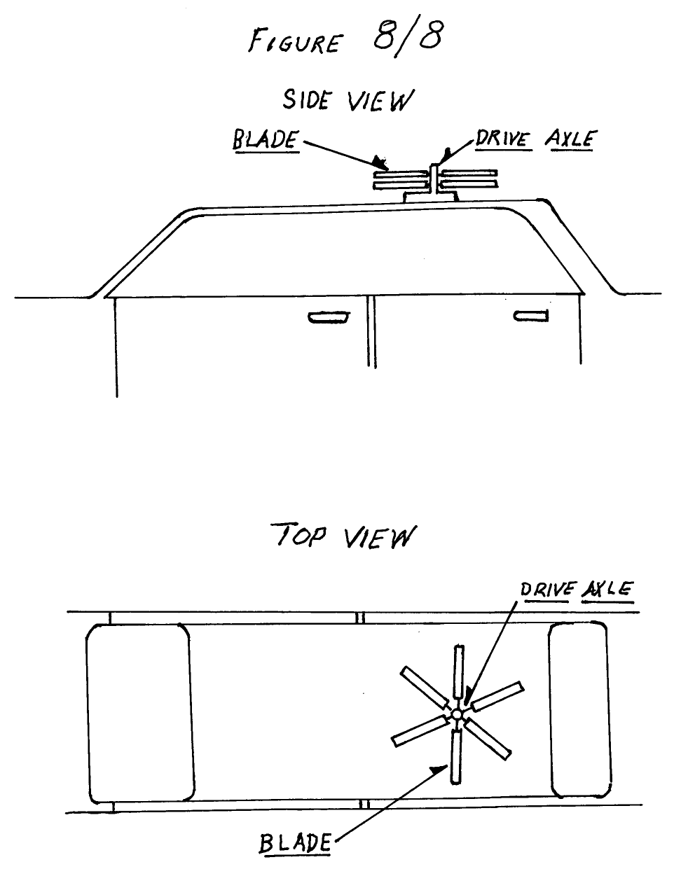

With two hub assemblies each containing three blades and rotated 180° from each other, the Andrews Turbine can be mounted on the top of a vehicle (FIG. 8/8). Using 16 inch long and 1 inch high blades, the complete turbine would measure 3 feet in diameter and 3 inches high. This vehicle turbine could trickle charge batteries whether the vehicle is moving or not. The turbine would not interfere with the operation of the vehicle. The gearbox and generator can be mounted under the roof or on top of the turbine.

The Andrews Turbine is capable of extracting energy from nature utilizing several mediums. The Andrews Turbine is made up of numerous horizontal blades symmetrically distributed about a vertical drive axle (FIGS. 4/8 and 5/8). Vertical partitions within the blades (FIG. 1/8) are necessary for extracting maximum energy from either wind or water.

1. WIND TURBINE (FIG. 6/8)
The Andrews Turbine is an efficient wind turbine and is classified as a Vertical Axis Wind Turbine (VAWT). The blades can vary in length, width and height depending on application and expected conditions. Utility-power generating application would require a larger and more robust blade than a small power application. The blade design would remain the same, just the dimensions would vary. The vertical partitions are critical for creating turbulence within the blade (FIG. 1/8) which results in extracting more energy from the wind. Like other VAWT designs, the Andrews Turbine turns no faster the wind speed. However by adding additional rotor sets (FIG. 6/8) to the drive axle the torque of the drive axle is increased. Since horsepower is expressed as torque X rpm/63,000, horsepower can be increased by either increasing the torque or the rpms. Since one horsepower is equal to 746 watts, increasing the horsepower increases the electrical output of the turbine. The Andrews Turbine utilizes a vertical drive axle and numerous horizontal blades that are stacked and arranged symmetrically about the drive axle (FIGS. 4/8 and 5/8). This results in a compact unit that can be easily mounted towers, unlike most other VAWT's (FIG. 6/8). With a length of six feet and a height of 4 inches per blade, three blades per hub and using three rotor sets the turbine would contain 36 blades and would occupy a cylindrical volume 13 feet in diameter and 18 feet in height. This is the equivalent of using three blades with a sweep diameter of 156 feet. This exceeds the sweep diameter of current utility power Horizontal Axis Wind Turbines (HAW). A serious public relation problem with HAWT's exists because they generate Noise and kill a large number of birds. Because the blades of the Andrews Turbine rotate at the speed of the wind, these two problems are eliminated.

2. WATER TURBINE (FIG. 7/8)
The Andrews Turbine is capable of generating electricity from water flow such as a river. The design with a vertical drive axle and horizontal blades makes a compact package but with a large amount of blade exposure to the current. The vertical partitions create turbulence within the blade thus imparting additional energy (torque), to the drive axle. By adding Rotor sets to the drive axle the torque of the drive axle is also increased. This increase of torque allows for the use of a high ratio gear box allowing for the efficient operation of the Andrews Turbine in low speed current conditions. By building angled bulkheads the current can be increased across the blades (FIG. 7/8). Since most major cities are located near large rivers, a number of Andrews Turbine could provide the entire city and surrounding area with non-polluting, low cost utility power. The power would be constantly generated unlike wind turbines which generate electricity only when the wind is blowing.

3. VEHICLE TURBINE (FIG. 8/8)
By adding an Andrews Turbine to automobiles and trucks, electric vehicles will finally have a useful cruising range and be less dependent on being plugged in to utility power to charge the batteries. The design of the Andrews Turbine lends itself to a roof top mount on vehicles and by varying the dimensions of the blades the turbine can be mounted without interfering with the design of the vehicle. By utilizing 16 inch blades that are one inch high, two three blade rotor sets can be mounted within a 3 foot diameter, 6½ inch tall enclosure. Most cars are driven only a few hours of the day, to and from work, the remainder of the time the vehicle is parked. If the wind is blowing while the vehicle is parked, the Andrews Turbine can trickle charge the batteries. By changing the gearbox and generator the Andrews Turbine could also charge the batteries while the vehicle is moving. In the past, wind turbines have been tested on vehicles without success. It takes more energy to push the turbine through the air than the turbine generates. Because of the compact design and rotational characteristics, the Andrews Turbine offers little wind resistance. The Andrews Turbine is capable of generating more power than it takes to push it through the air.
